(19) United States
(12) Patent Application Publication
(10) Pub. No.: US 2005/0210937 A1
(43) Pub. Date: Sep. 29, 2005

(54) Pushbutton lock

(75) Inventor: Hiroshi Okuda, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: Sure Interior Co., Ltd., Osaka-shi (JP)

(21) Appl. No.: 11/090,214

(22) Filed: Mar. 28, 2005

(30) Foreign Application Priority Data
Mar. 29, 2004 (JP) 2004-95047

(51) Int. Cl. E05B 13/00

(52) U.S. Cl. 70/214; 70/299

(57) ABSTRACT

Pushbutton lock where size reduction can be achieved by reducing the external dimension, including a planetary gear mechanism 18 where a drive gear serves as a sun gear 31 that is concentrically arranged within a casing 2 with an outside-house knob (operating member) 5, and a planetary gear 32a is arranged so that the range of revolution thereof with respect to the sun gear 31 overlaps the range of movement of a slider 17. Thereby, the slider 17 is moved in the unlock direction in response to the turning operation of the knob 5.

### BACKGROUND OF THE INVENTION

1. Field of the Invention

The present invention relates to pushbutton locks, which are employed in doors and so on, and are provided with a plurality of push buttons.

2. Description of the Related Art

As locking devices for the locking of, by way of example, doors, unlock code input-type pushbutton locks that do not require a key have been proposed. In pushbutton locks of this type a plurality of push buttons on which different numerals or the like are displayed are retractably provided on a casing, and the pushbutton lock is unlocked only when the buttons that coincide with the unlock code of these buttons have been push-operated (see Japanese Unexamined Patent Publication No. 2638476, Page 3, FIG. 4, for example).

More specifically, the pushbutton locks of the conventional art as described above include: a door opening/closing operating member such as a door knob that is turnably attached to the outer side of the casing; a drive gear concentrically attached within the casing to the operating member; and a plurality of tumblers provided for each of the push buttons that move to the back side of the casing in accordance with the push-operation of a corresponding push button. In addition, in the pushbutton lock provided is a lock mechanism that includes: a yoke plate-shaped slider freely movable in the direction orthogonal to the movement direction of the tumblers within the casing, in which projecting parts engageable with the tumblers are formed on the inner circumferential side; and a motion transmitting mechanism that converts the turning motion of the drive gear that accompanies the turning operation of the operating member into the linear motion of the slider, wherein the pushbutton lock is maintained in a locked state by the engagement of the slider projecting parts with the tumblers.

On the other hand, when the push buttons coincident with the unlock code and the tumblers connected thereto only are push-operated, all tumblers and slider projecting parts in the engaged state are released, allowing the slider to move and releasing the locked state of the lock mechanism with respect to the operating member. That is to say, the slider moves accompanying an operating force (turning force) on the operating member transmitted by way of the motion transmitting mechanism, and, by virtue of this, the pushbutton lock permits the door to be opened. It should be noted that pushbutton locks of this type include a “clear” button that allows for the clearing of erroneous operations including the erroneous push-operation of the push buttons.

However, in the pushbutton locks of the conventional art as described above, a semicircular arc-shaped sector gear is arranged between the drive gear and the slider, and the turning motion of the drive gear is transmitted to the slider side by way of this interposed sector gear. Accordingly, this sector gear creates an obstruction that prevents the range of movement of the slider being brought nearer to the drive gear, and that prevents the distance between the drive gear and the slider as well as the external dimensions of the casing being reduced. As a result, the size reduction of the pushbutton lock is prevented.

### SUMMARY OF THE INVENTION

With the foregoing problems of the conventional art in view, it is an object of the present invention to provide pushbutton locks in which size reduction can be achieved by reducing the external dimensions.

A pushbutton lock of the present invention includes: a casing; a plurality of push buttons retractably provided on the front-surface side of the casing; a plurality of unlock and non-unlock tumblers, provided in the casing corresponding to the push buttons, that are moved to the rear side in the front-to-rear direction of the casing when the corresponding push buttons are push-operated; a slider provided in the casing so as to be movable in the direction orthogonal to the direction of movements of the tumblers, which are permitted to move in the unlock direction within the casing when only the unlock tumblers are push-operated by the push buttons; a door opening/closing operating member, turnably provided on the front-surface side of the casing, that includes in the casing a drive gear concentrically arranged with respect to the turning center thereof; and a planetary gear mechanism that includes the drive gear serving as a sun gear and planetary gears arranged so that the range of revolution thereof with respect to the sun gear overlaps the range of movement of the slider, for moving the slider in the unlock direction by the revolving motion of the planetary gears.

In pushbutton locks of the constitution as described above, by virtue of the fact that the slider is moved in the unlock direction by the planetary gear mechanism having planetary gears arranged so that the range of revolution with respect to the sun gear that serves as a drive gear overlaps the range of movement of the slider, different from the above-described example of the conventional art, the range of movement of the slider can be brought nearer to the drive gear. As a result, the distance between the drive gear and the slider can be reduced, and the exterior dimensions of the casing can be reduced.

In addition, it is preferable that in the abovementioned pushbutton lock an escape recess arranged opposite to the drive gear side be formed in the slider.

In this case, compared to a case in which there is no such an escape recess formed, the distance between the slider and the drive gear as well as the exterior dimensions of the casing can be further reduced.

Moreover, it is preferable that the planetary gear mechanism of the abovementioned pushbutton lock include: a fixed frame provided in the casing with fixed inner teeth with which the sun gear meshes; a plurality of planetary gears that mesh with the sun gear and the inner teeth, and that revolve while rotating on their own axes about the sun gear; and a holding member that holds the revolving planetary gears to be able to rotate on their own axes so as to revolve with the planetary gears and that has an abutting part that abuts the slider.

In this case, the abutting part abuts the slider to move the slider in the unlock direction when the holding member revolves with the planetary gears about the sun gear. By virtue of this, compared to a case in which, instead of the fixed frame having inner teeth, the abutting part is provided on a rotating frame with teeth that mesh with the planetary gears at the outer perimeter of the planetary gears, and the slider is driven by, following the turning of the planetary gears and the rotating frame in sequence by the turning operation of the sun gear, the abutting of the abutting part of the rotating frame, the slider can be driven with suppressed generation of rattle at the gear meshing parts between the sun gear and the abutting part, and can be moved smoothly.

Furthermore, the abovementioned pushbutton lock may include: urging members for returning the tumblers to the original non-push-operated positions; a clear actuating body that has a positioning part for holding the tumblers at the push-operated positions and that is provided in the casing so as to be able to move in the same direction as the slider; and a cam member, concentrically provided in the casing with respect to the turning center of the operating member, that actuates the clear actuating body in accordance with the turning operation of the operating member.

In this case, when the abovementioned push buttons are erroneously push-operated or the like, a clear operation is implemented in which the cam member actuates the clear actuating body in accordance with the turning operation of the operating member, and the urging members return the tumblers to the non-push-operated positions. Accordingly, the provision of a special “clear” button for implementation of the clear operation can be omitted and reduction in pushbutton lock costs can be achieved.

Also, it is preferable that in the abovementioned pushbutton lock cam surfaces that abut and actuate the clear actuating body be provided symmetrically in the cam member.

In this case, by virtue of the fact that the cam surfaces of the cam member are provided symmetrically, the cam member can have equivalent application on pushbutton locks of two types in which the operating member is turn-operated to the left or to the right, and as the result of the shared use of component parts of different pushbutton locks, cost reduction can be achieved.

### BRIEF DESCRIPTION OF THE DRAWINGS

FIG. 1 is a side view illustrating the attached state of a pushbutton lock according to one embodiment of the present invention;

FIGS. 2A and 2B are exterior views as seen from the outside-house side and the inside-house side, respectively of the abovementioned push button key;

FIG. 3 is an expanded vertical cross section illustrating the constitution of the main part of the casing inner part shown in FIG. 1;

FIG. 4 is an expanded plan view of the constitution of the main part of the abovementioned casing inner part as seen from the inside-house side;

FIG. 5 is a cross section taken along the line V-V of FIG. 4;

FIGS. 6A and 6B are front views of the unlock and non-unlock tumblers shown in FIG. 5;

FIG. 7 is a perspective view illustrating the relationship between the abovementioned tumblers and the clear actuating body shown in FIG. 5;

FIG. 8 is an explosive view of the operating member, turning body and planetary gear mechanism shown in FIG. 3;

FIG. 9A is a plan view of the gear guide provided in the abovementioned planetary gear mechanism as seen from the outside-house side, and FIGS. 9B and 9C are cross sections taken along the lines IXb-IXb and IXc-IXc of 9A, respectively; and

FIG. 10 is an expanded plan view of the abovementioned turning body as seen from the inside-house side.

### DETAILED DESCRIPTION OF THE PREFERRED EMBODIMENTS

A description is given below, with reference to the drawings, of preferred embodiments of a pushbutton lock of the present invention. It should be noted that the description given below pertains to the application of the pushbutton lock of the present invention in, by way of example, the entrance door of a home.

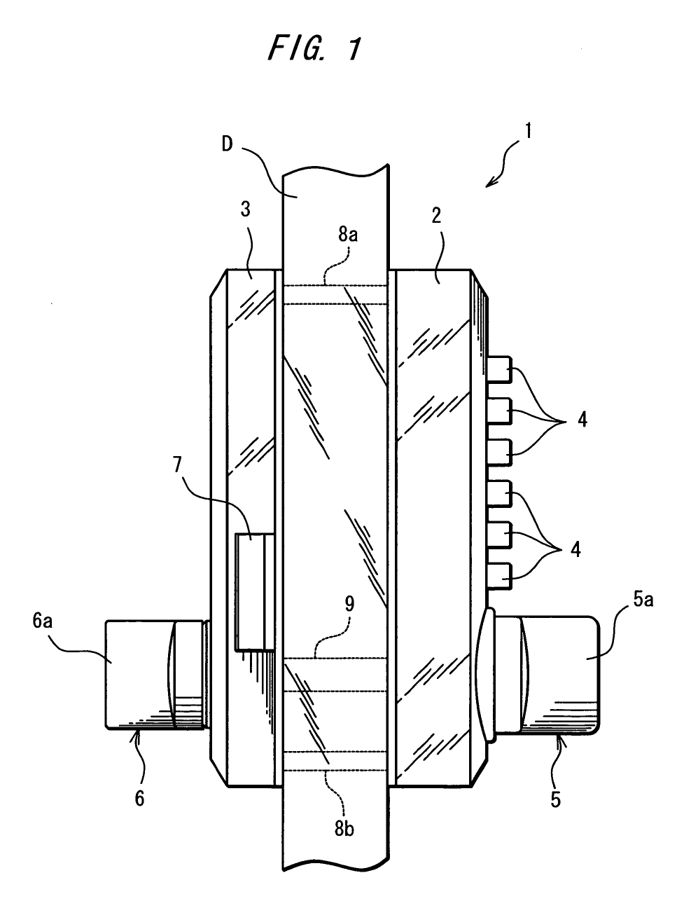

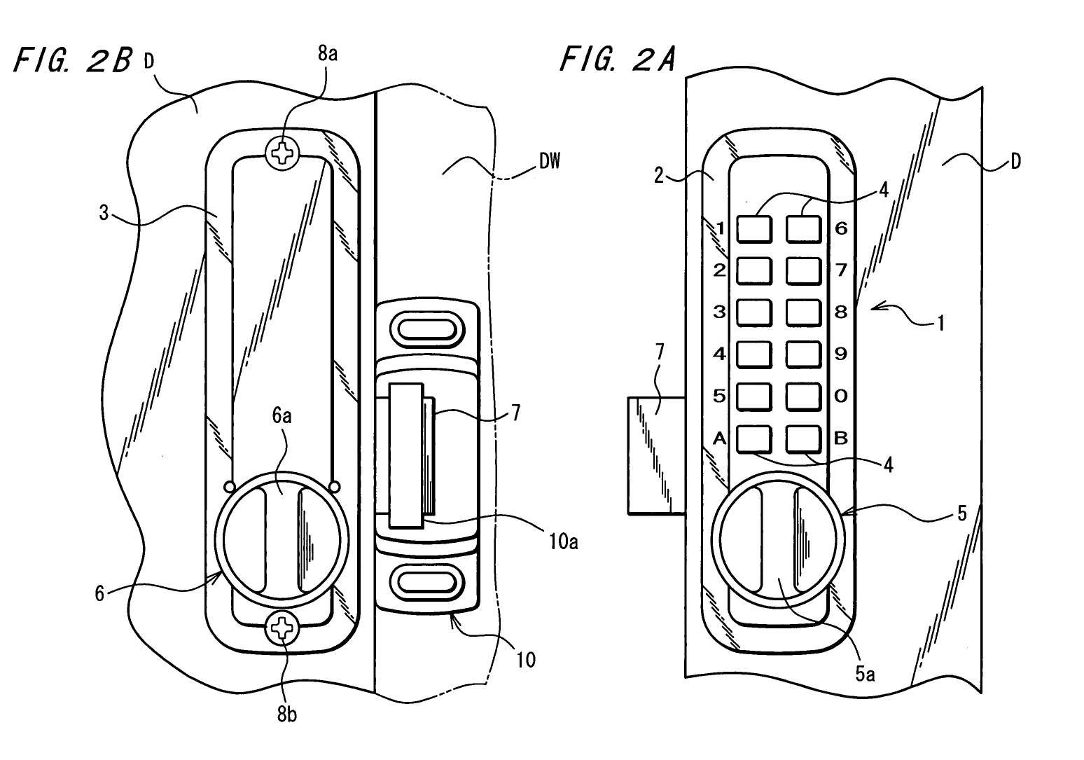

FIG. 1 is a side view that illustrates the attached state of a pushbutton lock according to one embodiment of the present invention, and FIGS. 2A and 2B are exterior views of the pushbutton lock as seen from the inside-house side and the outside-house side, respectively. FIG. 1 and FIG. 2 show the pushbutton lock 1 of this embodiment includes a casing 2 installed in the outside-house side of a door D and a decorative cover 3 attached to the inside-house side of the door D. A plurality of push buttons 4, by way of example, 12 in total arranged in two rows of six, and an outside-house knob 5 for opening and closing the door D from the outside are provided in the casing 2. In addition, the decorative cover 3 includes an inside-house knob 6 for opening and closing the door D from the inside, and a plate-like latch member 7 that projects to the door frame DW side from an opening part formed on the side of the decorative cover 3. The casing 2 and the decorative cover 3 are fixed to corresponding positions at the inside and the outside of the door D by attachment bolts 8a, 8b that pass through the door D from the inside-house side.

The abovementioned outside-house side knob 5 and inside-house side knob 6 include finger parts 5a and 6a configured to project from the outside-house side and inside-house side, respectively, and are turnably attached to the corresponding casing 2 and decorative cover 3, respectively. In addition, the knobs 5, 6, which are concentrically arranged on the inside-house side and the outside-house side, are connected to one end and the other end, respectively, of a latch drive shaft 9 arranged to pass through the door D. In addition, the latch member 7 is connected within the decorative cover 3 to the latch drive shaft 9, and by the turning of the latch drive shaft 9 in response to the turning operation of the outside-house side knob 5 and the inside-house side knob 6, the latch member 7 is pulled to the inner side of the decorative cover 3. By virtue of this, the latch member 7 is moved from an engaged state (shown in FIG. 2B) in which a projecting end part thereof is engaged with a yoke-shaped receiver part 10a of a latch receiver fitting 10 fixed to the door frame DW to the inner side of the decorative cover 3 so as to be released from this engaged state, whereupon the opening of the door D is permitted.

In addition, of the outside-house side knob 5 and the inside-house side knob 6, the knob 5 composes a door opening/closing operating member, turning operation of which is locked by a later-described lock mechanism, and includes a turning body and a drive gear concentrically arranged with respect to the turning center thereof. As the result of the obstruction to the turning of the latch drive shaft 9 and to the accompanying movement of the latch member 7 due to the locking by the abovementioned lock mechanism of the turning operation of the outside-house knob 5, the pushbutton lock I maintains the locked state of the door D. On the other hand, the inside-house knob 6, which is configured so that the latch drive shaft 9 and the latch member 7 are turned in sequence irrespective of the operating state of the lock mechanism, allows for the setting of the door D in either the locked or the unlocked state as required.

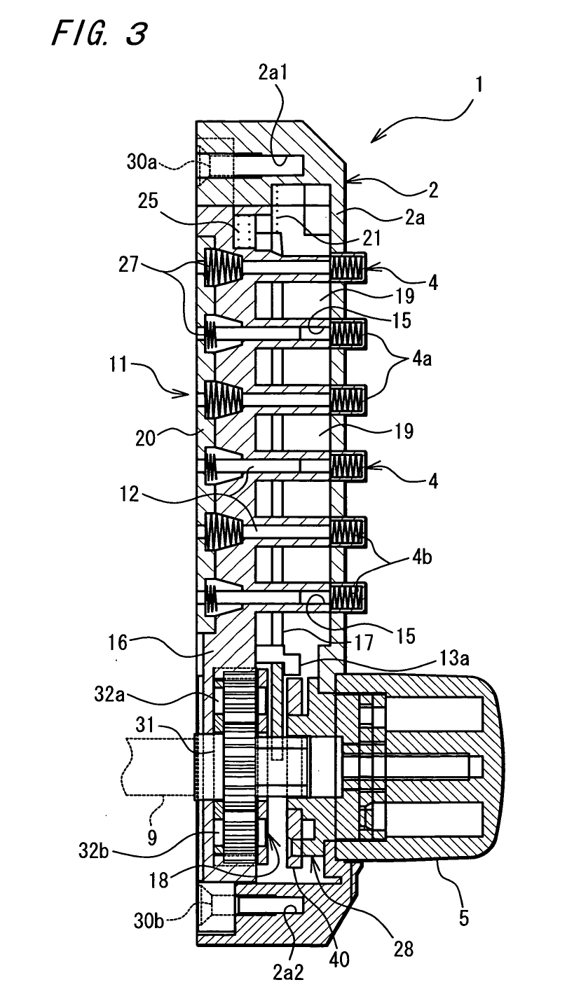

The abovementioned plurality of push buttons 4, which as seen in FIGS. 3 to 5 are retractably provided on the front-surface side of the casing 2, are configured in such a way to allow for the digital input of an unlock code that produces the unlock state of the pushbutton lock 1. That is to say, numerals 0 to 9 and alphabetic letters A and B that are input as an unlock code accompanying the push-operation of the push buttons are inscribed for display on the front surface of the casing 2 in the proximity of each button.

In addition, tumblers 12 provided to be able to move in the casing 2 in the front-to-rear direction thereof (left-to-right direction in FIG. 3) are connected to the push buttons 4. The tumblers 12 are configured so as to be moved from non-push-operated positions within the casing 2 to push-operated positions at the rear side in the front-to-rear direction of the casing 2 in response to the push-operation of the corresponding push buttons 4, and to be held at the push-operated positions. Moreover, the tumblers 12 are composed of unlock tumblers 12a that make up the abovementioned unlock code and non-unlock tumblers 12b that maintain the locked state of a lock mechanism 11 and, using the pushbutton lock 1, the locked state produced by the lock mechanism 11 is unlocked only when an unlock code set in advance is correctly input, that is to say, only when the unlock tumblers 12a are moved to the push-operated positions by the push buttons 4.

The abovementioned lock mechanism 11, as shown in FIGS. 3 to 5, includes a guide groove 14 for a clear actuating body 13 that extends in a lengthwise direction of the casing 2 (top-to-bottom direction of FIG. 3) that is formed in the center in a width direction, and a base plate 16 with a plurality of tumbler insert holes 15 formed on both sides of the groove 14. The base plate 16 is detachably attached to a main body 2a of the casing 2 by means of bolts 30a, 30b. It should be noted that the bolt holes into which these bolts 30a, 30b are screwed are formed in parallel positions in the width direction of the casing with bolt holes 2a1, 2a2 through which the attachment bolts 8a, 8b pass.

In addition, the lock mechanism 11 includes: a slider 17 slide-movable on the upper side of the casing 2 in the lengthwise direction (upper side of FIG. 3) with respect to the base plate 16 and is slidably arranged on the outside-house side of the base plate 16; a planetary gear mechanism 18 that serves as a motion transmitting mechanism for moving the slider 17 in response to the turning operation of the outside-house knob 5; a tumbler support base 19 that overlaps with the slider 17 on the outside-house side; and a rear cover 20 for covering the open section formed on the inside-house side of the base plate 16.

The tumblers 12 are movably inserted in the inside-to-outside-house direction (left-to-right direction of FIG. 3) in the plurality of tumbler insert holes 15, and furthermore the tumblers 12 are movably inserted In insert holes 19a provided in the tumbler support base 19.

The slider 17, which is formed as a plate-shaped frame configured so as to enclose all of the tumbler insert holes 15, is moved in the lengthwise direction by the planetary gear mechanism 18 in a state in which it is constantly urged to the planetary gear mechanism 18 side by a compression spring 21 interposed between the upper plate of the casing 2 and the slider 17. In addition, recessed parts 17a and projecting parts 17b configured to be able to engage and disengage with one side of the tumblers 12 in the width direction are connectively formed in a sliding direction at both the inner perimeter left and right edge parts of the slider 17. Furthermore, the slider 17 is supported by a pin 23 that is urged to the outside-house side by a coil spring 22, and thus, if the tumblers 12 contact the slider 17 when a push-operation is performed, the slider 17, resisting the coil spring 22, moves to the inside-house side. Accordingly, this makes it difficult to infer the unlock code based on changes in the push-operation feel of the push buttons 4 resulting from contact between the tumblers 12 and the slider 17.

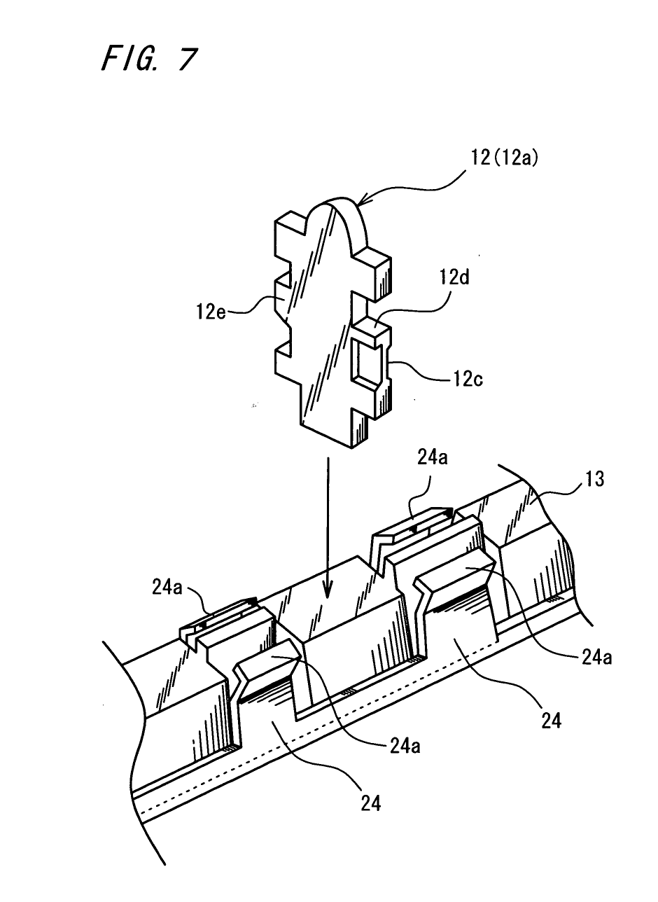

The abovementioned clear actuating body 13, which is slidably provided in the same direction as the slider 17 within the guide groove 14 of the base plate 16 (that is to say, the abovementioned lengthwise direction), includes a holding function for holding the tumblers 12 at the push-operated positions and a clear function for returning the tumblers 12 held at the push-operated positions by movement in the lengthwise direction to the non-push-operated positions. In other words, bifurcated positioning springs 24 that serve as positioning parts are provided in each tumbler 12 on the inside-house side of the clear actuating body 13, and the positioning parts 24 hold the tumblers 12 that have been moved to the push-operated positions (see FIG. 7).

In addition, the clear actuating body 13 is arranged between the tumblers 12 aligned in two rows in the casing 2, and by a downward spring 25 interposed between the actuating body 13 and the upper plate of the casing 2, it is constantly urged to the lower side in the lengthwise direction independent of the slider 17. Moreover, as shown in FIG. 3, a latch section that extends to the outside-house side and abutting the inner circumferential lower edge part of the slider 17 latches the slider 17, and an extend section that extends from this latch section to the planetary gear mechanism 18 side, are provided in a lower end part 13a of the clear actuating body 13. By the contacting of the lower end part 13a with a later-described cam member 40 provided in the abovementioned turning member 28 of the outside-house knob 5 within the casing 2, the clear actuating body 13 is moved to the upper side in the lengthwise direction so as to move the tumblers 12 held by the positioning springs 24 to the non-push-operated positions.

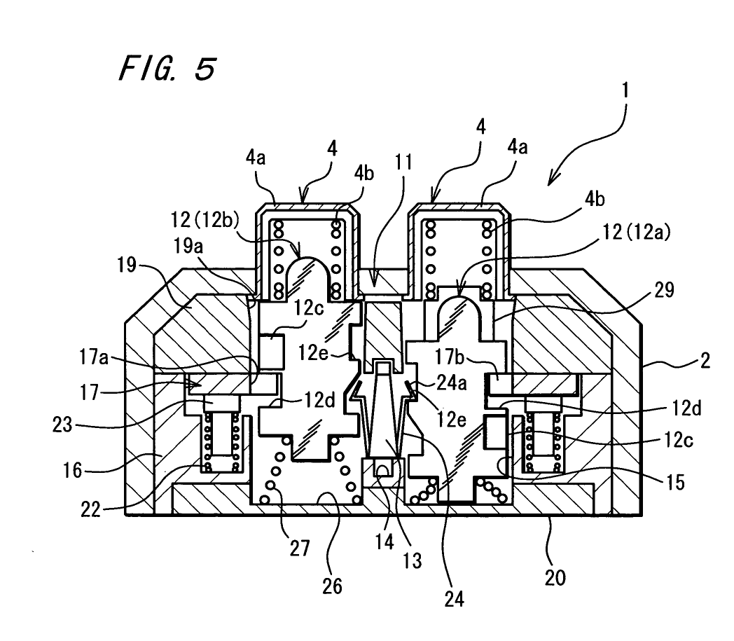

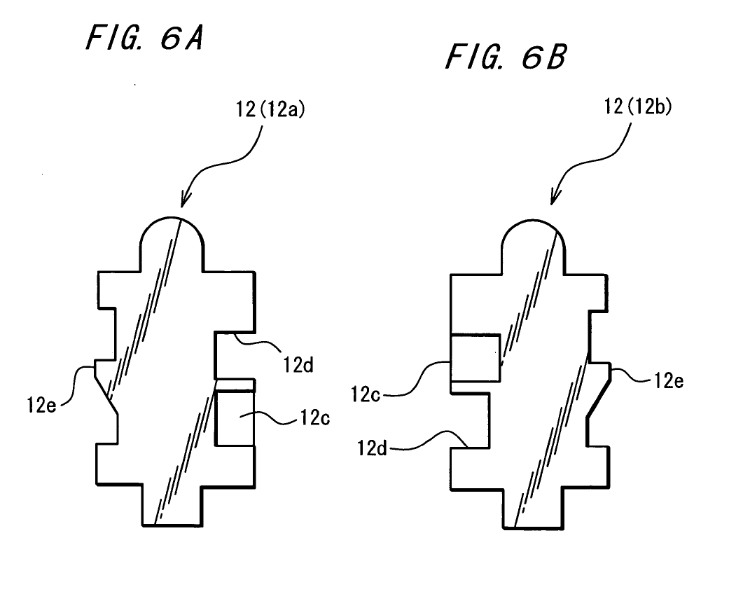

As shown in FIG. 5 and FIG. 6, a lock part 12c and unlock groove 12d with which the recessed part 17a and projection part 17b of the slider 17 engages and disengages are formed in an uneven shape at one side in the width direction of the tumblers 12. In addition, a latch part 12e that latches with a tip-end hook part 24a of the positioning spring 24 is formed on the other side of the tumbler 12 in the width direction. The tumblers 12 are mounted in the tumbler insert holes 15 so that the side in which the latching part 12e is formed faces the center side of the casing 2.

In addition, a spring housing part 26, which houses a return spring 27 that serves as an urging member for urging the tumbler 12 to the casing 2 front side, is formed on the rear cover 20 side of the tumblers 12, and the tumblers 12 are constantly urged to the front-surface side by the corresponding return spring 27. By virtue of this, as shown by the tumbler 12a on the right side of FIG. 5, although at times of push-operation by the connected push button 4 the latching part 12e thereof hooks on to a tip-end hook part 24a of the positioning spring 24 so that, resisting the urging forces of the return spring 27, the tumbler 12a is maintained at the push-operated position, the engagement with the positioning spring 24 is released when the clear actuating body 13 is moved to the upper side in the lengthwise direction, whereupon, as shown by the tumbler 12b on the left side of FIG. 5, the tumbler is pushed out toward the front-surface side of the casing 2 by the return spring 27, and is restored to the non-push-operated position.

In addition, in the abovementioned unlock tumbler 12a of the tumbler 12, as shown in FIG. 6A, the unlock groove 12d is formed more toward the front-surface side of the casing 2 than a lock part 12c. Accordingly, when the unlock tumbler 12a is at the push-operated position, the unlock groove 12d thereof is positioned within the frame of the slider 17 to prevent contact of the slider projecting part 17b with the tumbler 12a. On the other hand, when the tumbler 12a is at the non-push-operated position, slider movement to the upper side in the lengthwise direction of the slider 17 is regulated by the insertion of the lock part 12c thereof in the slider recessed part 17a to engage with the slider projecting part 17b.

In addition, as shown in FIG. 6B, the lock part 12c of the non-unlock tumbler 12b is formed more toward the front-surface side of the casing 2 than the unlock groove 12d. Accordingly, when the non-unlock tumbler 12b is at the non-push-operated position, the slide movement to the upper side in the lengthwise direction of the slider 17 is regulated by the positioning of the lock part 12c thereof in the frame of the slider 17 to be inserted in the slider recessed part 17a and to engage with the slider projecting part 17b. On the other hand, when the tumbler 12b is at the non-push-operated position, the unlock groove 12d is positioned within the frame of the slider 17 to prevent contact of the slider projecting part 17b with the tumbler 12b.

As is described above, using the abovementioned lock mechanism 11, the slide movement of the slider 17 is latched by the engagement of any one of the tumbler lock parts 12c with a slider projecting part 17b.

In addition, when all of the engaged states of the tumbler lock parts 12c and the slider projecting parts 17b have been released, in other words, when only the unlock tumblers 12a have been push-operated by the corresponding push buttons 4, the tumblers 12 permit the movement of the slider 17 within the casing 2 in the unlock direction (to the upper side in the lengthwise direction).

The abovementioned push buttons 4, as shown in FIG. 3 and FIG. 5, include a case 4a formed in a cylinder shape with a base, and a restore spring 4b that is attached within the case 4a. One end part of the restore spring 4b is connected to the bottom of the case 4a, and the other end part is connected to a protruding piece 29 (FIG. 5) that protrudes toward the outside-house side of the tumbler support base 19. As a result, after the push buttons 4 have been push-operated and the tumblers 12 connected to the push buttons 4 have been moved to the push-operated positions, only the push buttons 4 are automatically restored by the restore spring 4b to the original positions on the front-surface side of the casing 2.

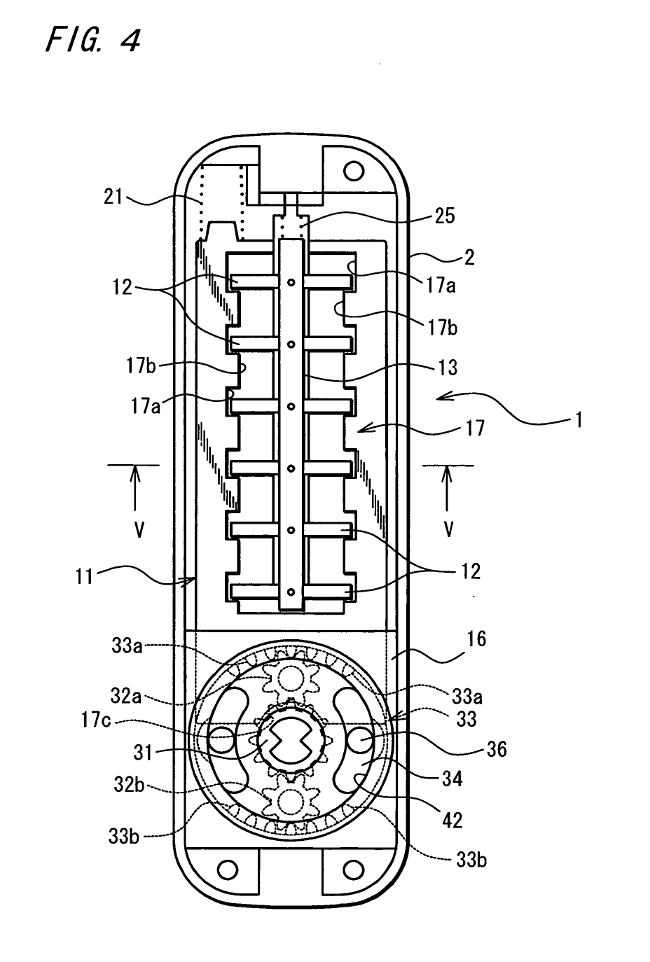

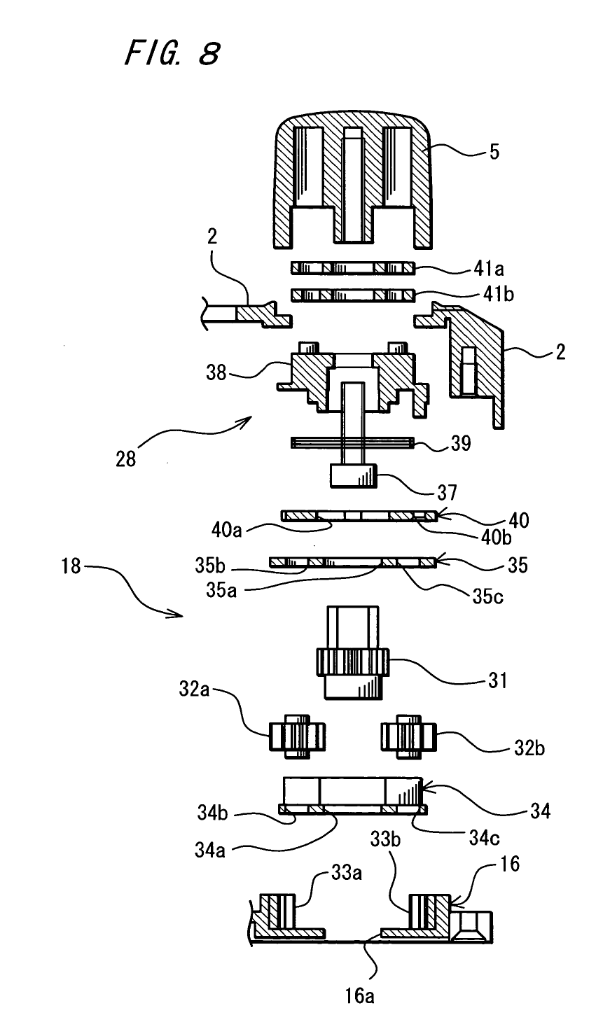

The abovementioned planetary gear mechanism 18 includes, with reference to FIG. 8, a sun gear 31 that serves also as the abovementioned drive gear of the outside-house knob 5 within the casing 2, and planetary gears 32a, 32b arranged on the upper side and lower side in the lengthwise direction of the casing 2 of the sun gear 31 to mesh with the sun gear 31. In addition, the planetary gear mechanism 18 includes fixed inner teeth 33a, 33b, provided in a ring-shaped fixed frame 33 (FIG. 4) fixed to the outer perimeter of the sun gear 31 that mesh with the planetary gears 32a, 32b, respectively, a gear guide 34 from which a holding member that holds the planetary gears 32a, 32b with freedom to self-rotate is configured, and a gear cover 35. The planetary gear mechanism 18, in the state in which the planetary gears 32a, 32b are held in the gear guide 34 and the gear cover 35 by the meshing of the sun gear 31 and the corresponding inner teeth 33a, 33b accompanying the turning operation of the sun gear 31 in response to the turning of the outside-house knob 5, revolves together with the gear groove 34 and the gear cover 35 while rotating on their own axes about the sun gear 31.

In addition, as shown in FIG. 4, the inner teeth 33a, 33b of the planetary gear 18, which are provided in the fixed frame 33 based on the turning range of the outside-house knob 5, are formed to correspond to the range of revolution of the planetary gears 32a, 32b that move in response to the turning of the knob 5.

Also, as shown in FIG. 4, the upper-side planetary gear 32a of the planetary gear 18 is arranged so that the range of revolution thereof with respect to the sun gear 31 overlaps the range of movement of the slider 17, whereby the lower end part of the slider 17 extends in proximity of the turning axis of the sun gear 31.

Moreover, as shown in FIG. 4, an escape recessed part 17c of a semicircular arc-shape arranged opposite to the sun-gear 31 side is provided in the lower end part of the slider 17, and the lower end part of the slider is configured in such a way that it can be arranged as close as possible to the sun gear 31.

The inside-house side end part of the abovementioned sun gear 31 is pulled to the inside-house side by way of through-holes 34a, 16a formed in the gear guide 34 and the base plate 16, respectively, and one end part of the abovementioned latch drive shaft 9 is connected, with play, in the direction of rotation thereof to a fan-shaped through-connection hole in the center part of this end part (FIG. 4). On the other hand, the outside-house side end part of the sun gear 31 protrudes to the outside-house side knob 5 side by way of an insert hole 35a formed in the gear cover 35. The turning body 28 of the outside-house knob 5 is connected to the outside-house side end part of the sun gear 31, and the sun gear 31 turns integrally with the knob 5 to function as the drive gear.

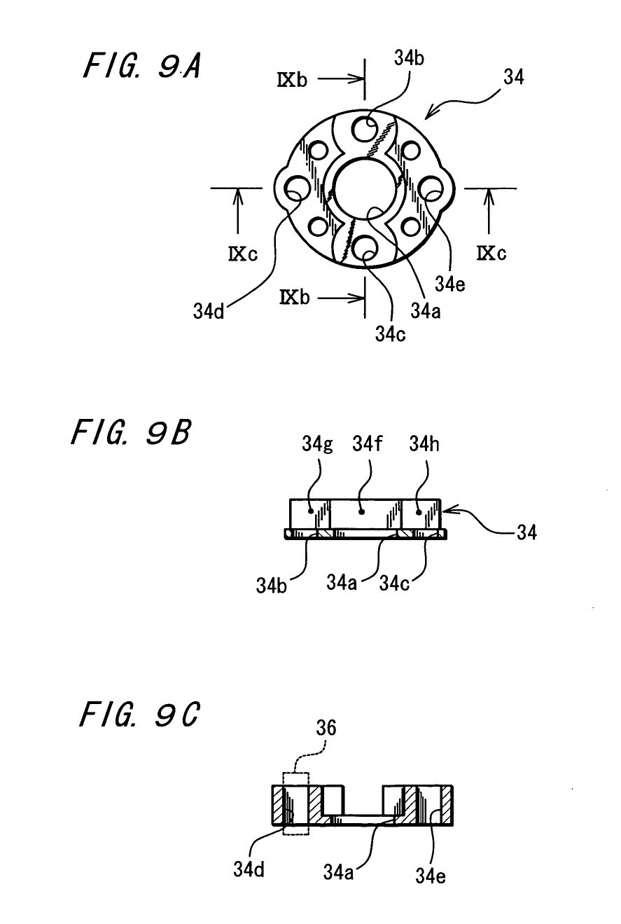

With reference again to FIG. 9, the through-hole 34a for the sun gear 31 and attachment holes 34b, 34c to which each of the inside-house side end parts of the planetary gear 32a, 32b are attached are formed on a straight line in the gear guide 34, and arranging spacers 34f, 34g, 34h secure the arrangement of the meshing parts of the gears 31, 32a, 32b in the interior of the gear guide 34. In addition, the outside-house side end parts of the planetary gears 32a, 32b are inserted into the attachment holes 35b , 35c (FIG. 8) formed in the gear cover 35, and the planetary gears 32a, 32b, accompanying the turning operation of the sun gear 31, rotate on their own axes between the gear guide 34 and the gear cover 35, and revolve with the gear guide 34 and the gear cover 35.

In addition, the gear guide 34 comprises attachment holes 34d, 34e to which an unlock pin 36 for unlocking the locked state of the abovementioned lock mechanism 11 in response to the turning operation of the outside-house knob 5 is attached. The unlock pin 36, with which an abutting part that abuts the slider 17 is configured, is configured so that the gear guide 34, accompanying the revolving motion of the planetary gears 32a, 32b, is able to abut the lower end surface of the slider 17 and drive the slider 17.

More specifically, the unlock pin 36 is arranged in either one of the attachment holes 34d, 34e based on the direction of the turning operation of the outside-house knob 5 for unlocking the pushbutton lock 1, and by way of example when the unlock direction of the pushbutton lock 1 constitutes the direction in which the outside-house knob 5 is moved in the clockwise direction (direction to the right as seen from the outside of the house), as shown in FIG. 9C, the unlock pin is mounted only in the left side attachment hole 34d as seen from the outside-house side.

In addition, the end part in the outside-house side of the abovementioned unlock pin 36 passes through a long hole 42 (FIG. 4) formed in the base plate 16 and, when the pin 36 is turned together with the gear guide 34, the unlock pin is guided by the long hole 42.

Moreover, the outside-house side end part of the unlock pin 36 is inserted though a through-hole formed in the gear cover 35 (not shown) and, furthermore, as shown in FIG. 4, the outside-house side end part of the pin 36 is arranged in proximity of the lower end part of the slider 17. By virtue of this, in the planetary gear 18, when an operating force imparted to the outside-house knob 5 in the unlock direction is transmitted to the sun gear 31 by way of the turning body 28, the planetary gears 32a, 32b turn (revolve) in the same direction as the outside-house knob 5 over the inner teeth 33a, 33b due to the turning force from the sun gear 31, and by the turning (revolving) of the gear guide 34 and the gear cover 35 in the same direction as the gear guide 34 accompanying this turning, the unlock pin 36 abuts the lower end part of the slider 17 causing the slider 17 to move linearly toward the upper side of the casing 2.

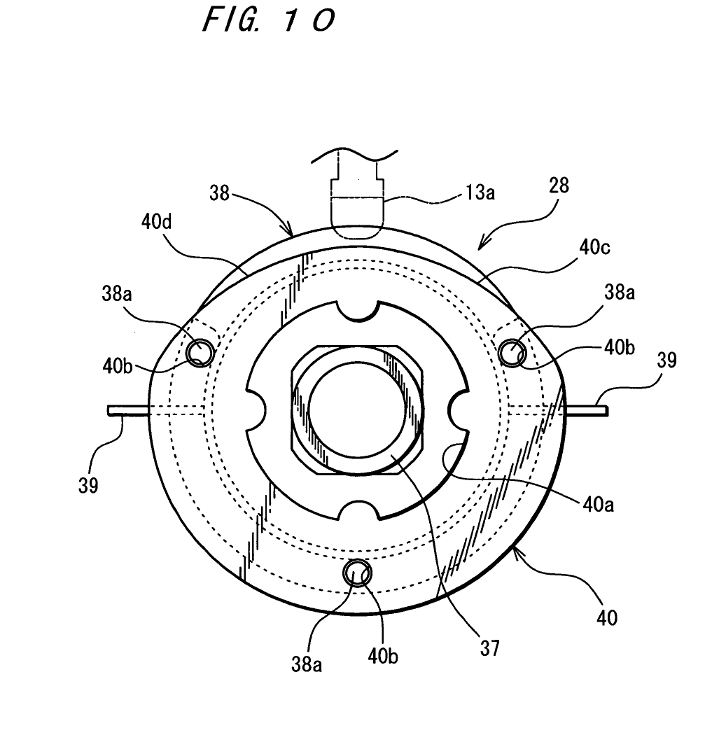

The abovementioned turning body 28, which with reference to FIG. 8 and FIG. 10, includes a turning core member 37, a cylindrical bearing part 38 to which the turning core member 37 is attached, and a wound spring 39 wound around the bearing part 38, turns in response to the operation of the knob part 5a of the outside-house knob 5. In addition, ball-receiving rings 41a, 41b for receiving a ball (not shown) urged by a spring arranged in the inner part of the outside-house knob 5 are provided on the outside-house side of the bearing part 38.

The outside-house side end part of the abovementioned turning core member 37 is inserted through an assembly hole formed in the bearing part 38 to be spline-coupled to the outside-house side knob 5. In addition, the inside-house side end part of the turning core member 37 is configured to couple with a spline hole formed in the outside-house side end part of the sun gear 31 so as to drive the sun gear 31 in response to the turning operation of the outside-house knob 5. Moreover, the free end of the wound spring 39 is latched to the inner surface of the casing 2, and the outside-house knob 5 is restored to its original position following the turning operation thereof by the elastic force of the wound spring 39.

In addition, the cam member 40 is provided concentrically with the turning body 28 on the inside-house side of the bearing part 38. The cam member 40, which actuates the clear actuating body 13 accompanying the turning operation of the outside-house knob 5, is, as shown in FIG. 10, configured from a plate member in which an insert hole 40a is formed in the approximate center section thereof, through which the outside-house side end part of the sun gear 31 is insertable. Moreover, as shown in FIG. 10, by way of example, three attachment holes 40b are formed in the cam member 40, and the cam member 40 is assembled in the turning body 28 in a state in which protrusions 38a provided on the inside-house side of the bearing part 38 have been passed through these attachment holes 40b.

In addition, circular arc-shaped cam surfaces 40c, 40d that are able to abut the lower end part 13a of the clear actuating body 13 are provided symmetrically on the upper side of the casing 2 of the cam member 40, and when the outside-house knob 5 is turned in either the left or right direction, one of the corresponding cam surfaces 40c, 40d abuts the lower end part 13a, causing the clear actuating body 13 to be moved to the upper side of the casing 2. By virtue of this, the cam member 40 returns tumblers 12 erroneously held at the push-operated positions due to an incorrect operation of the unlock code to the non-push-operated positions, whereupon the erroneously operated push buttons 4 are unlocked. In addition, the cam member 40 is configured so that the clear actuating body 13 is actuated in response to the unlock operation to the outside-house knob 5 when the unlock tumblers 12a only are held at the push-operated positions when a correct unlock code has been input, whereupon the outside-house knob 5 can be restored to its original position and the unlock tumblers 12a are automatically returned to the non-push-operated positions to produce the locked state of the push button key 1.

Using the push button key 1 of this embodiment as described above, due to the overlapping of the range of revolution of the upper side planetary gear 32a and the range of movement of the slider 17 in the planetary gear mechanism 18, the lower end part of the slider 17 extends in proximity of the turning shaft of the sun gear 31. As a result, compared to the abovementioned example of the conventional art that employs a sector gear, the range of movement of the slider 17 can be brought nearer to the sun gear (drive gear) 31, and the exterior dimensions of the casing 2 can be reduced in size. By virtue of this, the exterior dimensions of the pushbutton lock 1 can be reduced and size reduction of the pushbutton lock 1 can be easily achieved. In addition, by virtue of the fact that a compact pushbutton lock of small exterior dimensions can be configured in this way, the pushbutton lock 1 of this embodiment can be used as a locking device for small doors and so on for which application using the products of the conventional art was difficult, and because of the compact configuration of the pushbutton lock 1, cost reduction can be easily achieved. It should be noted that it was confirmed through comparison with a pushbutton lock of the same number of provided push buttons 4 of the conventional art that the external dimensions of the product of this embodiment could be shortened more than 20 mm.

In addition, in this embodiment, due to the provision of an escape recessed part 17c in the lower end part of the slider 17 so that the lower end part of the slider can be arranged as close as possible to the sun gear 31, the exterior dimensions of the casing 2 and the distance between the slider 17 and the sun gear 31 can be further reduced.

Moreover, in the abovementioned planetary gear mechanism 18 of this embodiment, due to the turning of the planetary gears 32a, 32b between the sun gear 31 and inner teeth 33a, 33b about the sun gear 31, the unlock pin 36 is caused to abut the slider 17 so as to drive the slider 17. On the other hand, in constitutions in which the slider is linearly motioned as the result of the abutting of a release pin, the slider is also considered to be able to be linearly moved by the unlock pin by the turnable provision of planetary gears at a fixed position, the turnable arrangement of a circumferential gear to which the release pin is attached, and the turning of the sun gear, planetary gear, and outer circumferential gear in sequence. However, in constitutions such as this there is a greater generation of rattle at the gear meshing parts within the planetary gear mechanism than in the product of this embodiment. In contrast therewith, the generation of rattle at the gear teeth meshing parts of the planetary gear mechanism 18 of the product of this embodiment is markedly suppressed, whereby the slider 17 can be moved smoothly and an improvement in the operability of the outside-house knob 5 can be achieved.

In addition, due to the provision of the cam member 40 able to abut the lower end part 13a of the clear actuating body 13 in the turning body 28 of the outside-house knob 5 in this embodiment, the installation of a special clear button for returning the tumblers 12 held at the non-push-operated positions can be omitted and, accordingly, cost reduction of the pushbutton lock 1 can be achieved. Moreover, in devices of the conventional art in which a clear button is employed, there have been difficulties associated with the implementing of the clear operation of the tumblers using the elastic forces of springs connected to the buttons and the like. In contrast, due to the implementation of the clear operation in the product of this embodiment based on the turning operation of the cam member 40 accompanying the turning operation of the outside-house knob 5, the clear operation can be implemented easily.

Furthermore, due to the symmetrical provision in this embodiment where cam surfaces 40c, 40d that abut the lower end part 13a, the cam member 40 can have application in pushbutton locks of two types for which the turn operation of the outside-house knob 5 is either to the left or to the right. Accordingly, sharing of component parts between different pushbutton locks is possible, and accordingly cost reduction can be achieved.

It should be noted that, although the description given above pertains to the application of the pushbutton lock of the present invention in an entrance door, provided a planetary gear mechanism is employed in which the drive gear on the operating member side is used as the sun gear and which includes a planetary gear arranged so that the range of revolution with respect to the sun gear overlaps the range of movement of the slider, this pushbutton lock may be employed as a locking device for the locking of doors provided indoors and so on. In addition, there are no particular restrictions to the number of push buttons to be provided or to the method for the arrangement thereof, and the device is able to have application where, by way of example, a plurality of push buttons are arranged in one row. Moreover, although the description given above pertains to a motion transmitting mechanism in which two planetary gears are employed, there are no restrictions to the number of planetary gears that may be arranged. Incidentally, although it is possible for the operation of the motion transmitting mechanism to be implemented in a more stable state by increasing the number of planetary gears, there is an existing demand for size reduction and high precision production and soon of the planetary gears. Accordingly, the installation of two planetary gears in the motion transmitting mechanism is preferred.

In addition, although the description given above pertains to a constitution in which locking is achieved by the provision of a latch member in a decorative cover arranged on the inside-house side, the present invention is in no way restricted to this constitution, and by way of example the locking device may be one in which a drive gear is connected to a door latch retractably provided through the side-end surface of the door and the door latch is driven in response to the turning operation of the operating member. Moreover, although the description given above pertains to an operating member with finger parts, the constitution and shape of the operating member is in no way restricted thereto, and by way of example an operating member having a lever that may be turn-operated with one hand or an operating member having a key hole in which a key for turning the sun gear may be inserted can be used.

1. A pushbutton lock, comprising:
a casing;
a plurality of push buttons retractably provided on a front-surface side of 5 the casing;
a plurality of unlock and non-unlock tumblers, provided in the casing corresponding to the plurality of the push buttons, that are moved to a rear side in a front-to-rear direction of the casing when the corresponding push buttons are push-operated;
a slider, provided in the casing so as to be movable in a direction orthogonal to a direction of movement of the tumblers, which is permitted to move in an unlock direction within the casing when only the unlock tumblers are push-operated by the push buttons;
a door opening/closing operating member, turnably provided on the front-surface side of the casing, that includes, in the casing, a drive gear concentrically arranged with respect to a turning center thereof; and
a planetary gear mechanism that includes the drive gear serving as a sun gear, and planetary gears arranged so that a range of revolution thereof with respect to the sun gear overlaps a range of movement of the slider, for moving the
slider in the unlock direction by a revolving motion of the planetary gears.

2. The pushbutton lock according to claim 1, wherein an escape recessed part arranged opposite to a side of the drive gear is formed in the slider.

3. The pushbutton lock according to claim 1 or 2, wherein the planetary gear mechanism comprises:
a fixed frame provided, in the casing, with fixed inner teeth with which the sun gear meshes;
a plurality of planetary gears that mesh with the sun gear and the inner teeth and revolve while rotating on their own axes about the sun gear; and
a holding member that holds the planetary gears to be able to rotate on their own axes so as to revolve with the planetary gears, and that comprises an abutting part that abuts the slider.

4. The pushbutton lock according to claim 1 or 2, comprising:
urging members for returning the tumblers to the original non-push-operated positions;
a clear actuating body that comprises positioning parts for holding the tumblers at push-operated positions, and that is provided in the casing so as to be able to move freely in a same direction as the slider; and
a cam member, concentrically provided in the casing with respect to a turning center of the operating member, that actuates the clear actuating body in accordance with a turning operation of the operating member.

5. The pushbutton lock according to claim 4, wherein cam surfaces that abut and actuate the clear actuating body are provided symmetrically in the cam member.

6. The pushbutton lock according to claim 3, comprising:
urging members for returning the tumblers to the original non-push-operated positions;
a clear actuating body that comprises positioning parts for holding the tumblers at push-operated positions, and that is provided in the casing so as to be able to move freely in a same direction as the slider; and
a cam member, concentrically provided in the casing with respect to a turning center of the operating member, that actuates the clear actuating body in accordance with a turning operation of the operating member.
